(19) United States
(12) Patent Application Publication
(10) Pub. No.: US 2021/0287194 A1
(43) Pub. Date: Sep. 16, 2021

(54) SYSTEMS AND METHODS FOR INCENTIVIZING THE USE OF A PAYMENT MECHANISM

(71) Applicant: JPMorgan Chase Bank, N.A., New York, NY (US)

(72) Inventor: Avin Arumugam, San Francisco, CA (US)

(21) Appl. No.: 14/921,716

(22) Filed: Oct. 23, 2015

Related U.S. Application Data
(60) Provisional application No. 62/068,045, filed on Oct. 24, 2014.
(60) Provisional application No. 62/089,693, filed on Dec. 9, 2014.

(51) Int. Cl. G06Q 20/12; G06Q 30/02; G06Q 20/36; G06Q 20/40; G06Q 20/38

(52) U.S. Cl. CPC G06Q 20/123; G06Q 30/0222; G06Q 20/363; G06Q 2220/00; G06Q 20/387; G06Q 20/3674; G06Q 20/401

(57) ABSTRACT

Systems and methods for incentivizing the use of a payment mechanism are disclosed. In one embodiment, a method may include: (1) a graphical user interface for a computer program executed by a computer processor offering a user an incentive in exchange for having a payment instrument associated with a financial institution in an electronic wallet for an electronic payment service application; (2) the graphical user interface for the computer program receiving acceptance of the offer; (3) the computer program generating a transaction; (4) the computer processor executing the electronic payment service application; (5) a graphical user interface for the electronic payment service application receiving a financial instrument to conduct the transaction; (6) the electronic payment service application verifying that the financial instrument is associated with the financial institution; (7) presenting a redemption message; and (8) the computer program initiating redemption of the incentive.

### RELATED APPLICATIONS

This application is related to U.S. Provisional Patent Application Ser. No. 62/089,693, filed Dec. 9, 2014, and U.S. Provisional Patent Application Ser. No. 62/068,045, filed Oct. 24, 2014. The disclosures of each of these provisional applications is hereby incorporated, by reference, in its entirety.

### BACKGROUND OF THE INVENTION

### 1. Field of the Invention

The present invention generally relates to systems and methods for incentivizing the use of a payment mechanism.

### 2. Description Of The Related Art

Mobile payment services, such as Apple's Apple Pay, Google's Android Pay, and Samsung's Samsung Pay, are becoming increasingly popular as they provide consumers with the ability to make payments with their mobile electronic devices. These applications typically store card information from the mobile device to a point of sale terminal in order to conduct a transaction.

### SUMMARY OF THE INVENTION

Systems and methods for incentivizing the use of a payment mechanism are disclosed. In one embodiment, a method for incentivizing the use of a payment mechanism in an electronic payment service application may include: (1) a graphical user interface for a computer program executed by a computer processor offering a user an incentive in exchange for having a payment instrument associated with a financial institution in an electronic wallet for an electronic payment service application; (2) the graphical user interface for the computer program receiving acceptance of the offer; (3) the computer program generating a transaction; (4) the computer processor executing the electronic payment service application; (5) a graphical user interface for the electronic payment service application receiving a selection of a financial instrument to conduct the transaction; (6) the electronic payment service application verifying that the financial instrument is associated with the financial institution; (7) the graphical user interface for the computer program presenting a redemption message; and (8) the computer program initiating redemption of the incentive.

In one embodiment, the transaction may be for a nominal account.

In one embodiment, the step of the electronic payment service application verifying that the financial instrument is associated with the financial institution may include the electronic payment service application verifying that a Bank Identification Number (BIN) or an Issuer Identification Number (IIN) for the financial instrument is associated with the financial institution.

In one embodiment, the incentive may include free or discounted music, a free or discounted application, etc.

In one embodiment, the computer program executed by a computer processor is a mobile banking application for the financial institution.

In one embodiment, the method may further include the electronic payment service application requesting a token for the financial instrument; the electronic payment service application receiving the token for the financial instrument; and the electronic payment service application adding the financial instrument to the electronic wallet.

In one embodiment, the token may be requested from a payment processing network, from the financial institution, etc.

According to another embodiment, a system for incentivizing the use of a payment mechanism in an electronic payment service application, may include (1) a graphical user interface for a computer program executed by a computer processor offering a user an incentive in exchange for adding a payment instrument associated with a financial institution in an electronic wallet for an electronic payment service application; (2) the graphical user interface for the computer program receiving a request to add the payment instrument to the electronic wallet; (3) the computer program generating a transaction; (4) the computer processor executing the electronic payment service application; (5) a graphical user interface for the electronic payment service application receiving an identification of a financial instrument to add to the electronic wallet and conduct the transaction; (6) the electronic payment service application verifying that the financial instrument is associated with the financial institution; (7) the electronic payment service application adding the financial instrument to the electronic wallet; (8) the graphical user interface for the computer program presenting a redemption message; and (9) the computer program initiating redemption of the incentive.

In one embodiment, the transaction may be for a nominal account.

In one embodiment, the step of the electronic payment service application verifying that the financial instrument is associated with the financial institution may include the electronic payment service application verifying that a Bank Identification Number (BIN) or an Issuer Identification Number (IIN) for the financial instrument is associated with the financial institution.

In one embodiment, the incentive may include free or discounted music, a free or discounted application, etc.

In one embodiment, the computer program executed by a computer processor is a mobile banking application for the financial institution.

In one embodiment, the step of the electronic payment service application adding the financial instrument to the electronic wallet may include the electronic payment service application requesting a token for the financial instrument; and the electronic payment service application receiving the token for the financial instrument.

In one embodiment, the token may be requested from a payment processing network, from the financial institution, etc.

According to another embodiment, a method for incentivizing the use of a payment mechanism in an electronic payment service application may include (1) a graphical user interface for an electronic payment service application executed by a computer processor receiving a request to conduct a transaction; (2) the electronic payment service application retrieving a token associated with a payment mechanism; (3) the electronic payment service application determining a Bank Identification Number (BIN) or an Issuer Identification Number (IIN) for the payment mechanism; (4) the electronic payment service application determining that the BIN or IIN is associated with an incentive for using the payment mechanism; (5) the electronic payment service application conducting the transaction with the payment mechanism; (6) the electronic payment service application conducting the transaction with the payment mechanism; and (7) the electronic payment service application initiating redemption of the incentive.

In one embodiment, the incentive may be offered by the issuer of the payment mechanism. In another embodiment, the incentive may be offered by a merchant associated with the payment mechanism.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for incentivizing the use of a payment mechanism according to one embodiment;

FIG. 2 depicts a method for incentivizing the use of a payment mechanism according to one embodiment;

FIGS. 3a-3d depict exemplary screenshots according to one embodiment;

FIG. 4 depicts an exemplary tokenization process according to one embodiment; and

FIG. 5 depicts a method for incentivizing the use of a payment mechanism according to another embodiment.

### DETAILED DESCRIPTION OF PREFERRED EMBODIMENTS

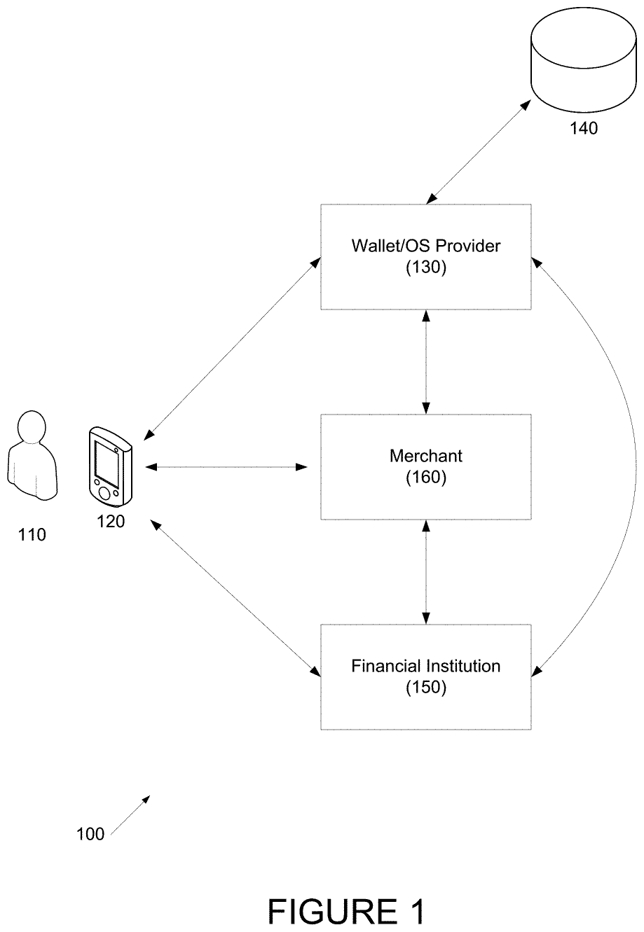

Several embodiments of the present invention and their advantages may be understood by referring to FIGS. 1-5.

Although embodiments may be disclosed in the context of a particular financial institution/issuer, a mobile payment application, mobile device, and/or wallet system, it should be recognized that these references are exemplary only and that the disclosure has applicability beyond these exemplary entities and devices.

Referring to FIG. 1, a system for incentivizing the use of a payment mechanism is disclosed according to one embodiment. System 100 may include user 110 that operates electronic device 120. Electronic device 120 may be any suitable electronic device from which payments may be made using a mobile payment/digital wallet service, such as mobile phones (e.g., “smart phones” such as the Apple iPhone, Samsung Galaxy, etc.), tablet computers (e.g., iPad), notebook computers, netbook computers, desktop computers, electronic wallet devices, etc.).

Electronic device 120 may communicate with one or more server (not shown) at financial institution 150 using, for example, a mobile application provided by financial institution 150. User 110 may be a customer of financial institution 150, and may have one or more account (e.g., checking, savings, credit card, etc.) with financial institution 150.

In one embodiment, financial institution 150 may be a credit card issuer and may issue one or more credit cards to user 110.

Electronic device 120 may also communicate with electronic wallet provider and/or operating system provider 130. An example of provider 130 is Apple, which provides an electronic wallet (e.g., Apple Pay) and an operating system (e.g., iOS for the iPhone). Another example is Google, which provides the Android operating system and the Android Pay payment service. Other wallet providers and operating system providers may be provided as is necessary and/or desired.

In one embodiment, the wallet provider and the operating system provider may be different entities. For example, CurrentC, a mobile payment platform, may operate on iOS or Android. Similarly, Samsung provides Samsung Pay for the Android operating system.

In one embodiment, provider 130 may communicate with database 140, which may hold a resource. For example, resources may include digital content (e.g., music, movies, photos, etc.), discounts, tickets, rewards, etc. Any suitable resource may be provided as is necessary and/or desired.

In one embodiment, electronic device 120 may execute one or more applications (“apps”) that provide the ability to make payments (e.g., mobile payment applications) or purchases from within the application (“in-app purchase”).

In one embodiment, merchant 160 may provide an application that is executed by electronic device 120.

In one embodiment, electronic device 120, provider 130, database 140, financial institution 150, and/or merchant 160 may communicate using one or more suitable communication and/or payment network.

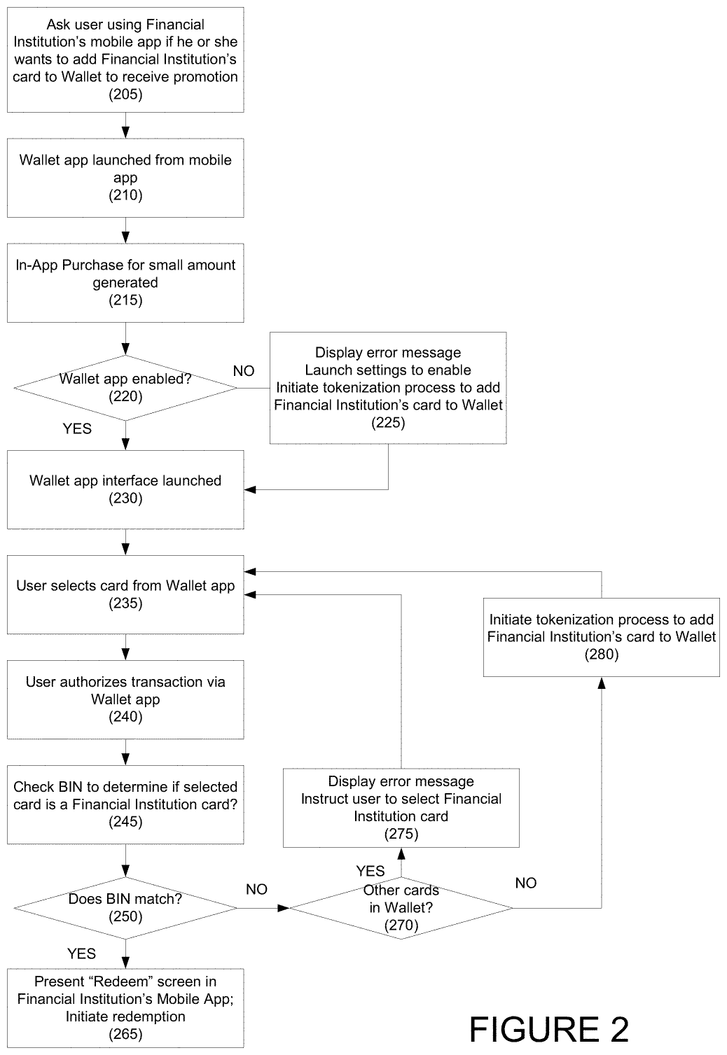

Referring to FIG. 2, a method for incentivizing the use of a payment mechanism is disclosed according to one embodiment. In step 205, a user may use a mobile application for a financial institution/issuer. The mobile application may inquire whether the user would like to add a payment mechanism issued by the financial institution/issuer, such as a credit card, to a third party wallet or payment application. In one embodiment, the user may be provided with an incentive or promotion, such as free or discounted music, e-books, videos, ringtones, apps, rewards, discounts, coupons, items, etc. in exchange for adding, or having, the payment mechanism in the third party wallet.

In one embodiment, the user may already have the payment mechanism in the third party wallet, and may be able to redeem the incentive without having to add the payment mechanism again.

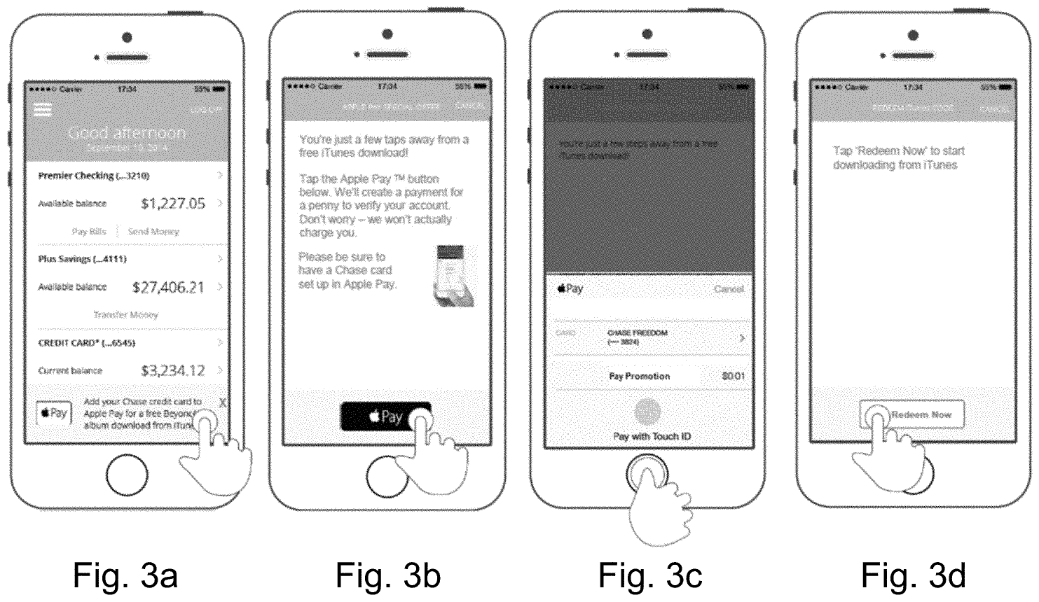

FIG. 3a depicts an example screenshot of an “add payment mechanism” interface according to one embodiment. It should be noted that although this example is provided in the context of Apple Pay as the wallet application, and free music as an incentive, it should be noted that these are exemplary only. Other operating systems, wallet applications, incentives, etc. may be used as is necessary and/or desired.

Referring again to FIG. 2, in step 210, the third party wallet application may be launched from the mobile application, and, in step 215, the mobile application may generate an in-application purchase. In one embodiment, this may be for a small amount. In one embodiment, the in-application purchase may be for a purchase with the financial institution/issuer. The financial institution/issuer may or may not actually charge the user for the in-application purchase.

In one embodiment, the generation of the in-application purchase may cause the third party wallet application to initialize and execute.

FIG. 3b depicts an example screenshot of the launching of the third party wallet application as well as the messaging regarding the generation of a small in-application purchase.

Referring again to FIG. 2, in step 220, the mobile application and/or the mobile device operating system may verify that the third party wallet application is installed and/or enabled on the mobile device. If it is not, in step 225, an error message may be displayed for the user informing the user that the third party wallet application is not installed or enabled. For example, the user may be presented with a message such as “Please download the Wallet App to continue” and may be directed to the on-line applications store. In another embodiment, the user may be presented with a message such as “Please enable the Wallet App” and may be linked to the settings menu. In still another embodiment, the user may be presented with a message such as “Please add a card to the Wallet App in order to redeem your free download.”

In one embodiment, the message may be provided in a pop-up window, a new window, etc. In one embodiment, the user may be asked whether or not to download the third party wallet application.

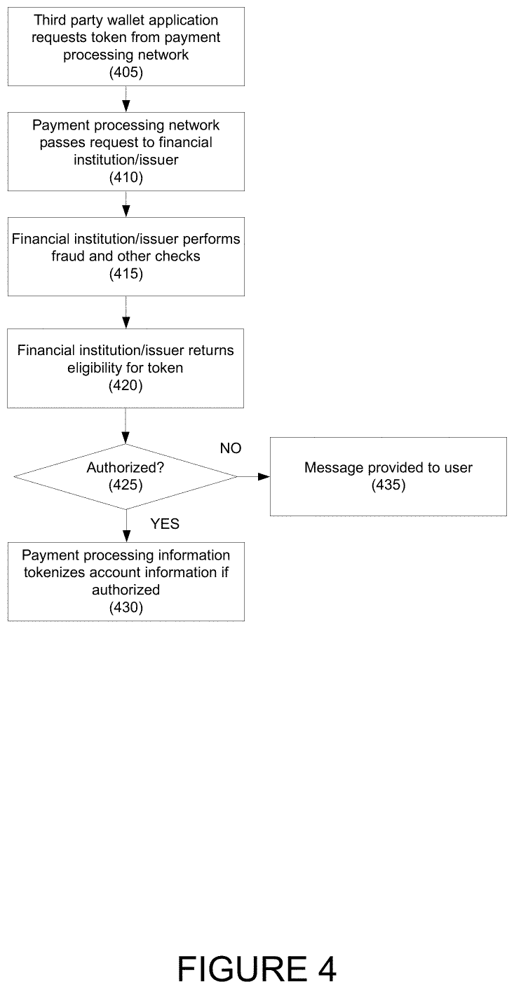

In one embodiment, a tokenization process, discussed below with reference to FIG. 4, may be used as necessary to add a card for the financial institution/issuer to the third party wallet application.

In step 230, if the third party wallet application is enabled, the third party wallet application interface may be launched or initiated.

In step 235, the user may be presented with one or more payment mechanisms to complete the transaction, and may select one of the payment mechanisms. In one embodiment, if only a single payment mechanism is in the third party wallet application, that payment mechanism may be automatically selected.

In step 240, the user may authorize the transaction using the selected payment mechanism. In one embodiment, the user may simply actuate a “pay” button, or similar actuator, on the screen, on the device, etc.

FIG. 3c depicts an example screenshot depicting the third party wallet application superimposed over a screen of the mobile application. In one embodiment, the third party wallet application may identify the payment mechanism (e.g., Chase Freedom), the launching of the third party wallet application, and the messaging regarding the generation of a small in-application purchase.

In step 245, the third party wallet application may initiated payment authorization for the small amount. The financial institution/issuer, payment network, and/or a payment processor may check to see if the payment mechanism selected is a payment mechanism associated with the financial institution/issuer.

In step 250, the financial institution/issuer, payment network, and/or payment processor may check the Bank Identification Number (BIN) or Issuer Identification Number (IIN) for the payment mechanism to see if it is associated with the financial institution/issuer.

In one embodiment, the payment processor or payment network may determine whether the payment mechanism selected is a payment mechanism associated with the financial institution/issuer, and may return the result of this determination to the financial institution/issuer.

In another embodiment, the payment processor or payment network may provide the BIN or IIN to the financial institution/issuer, and the financial institution/issuer may determine whether the payment mechanism selected is a payment mechanism associated with the financial institution/issuer.

In yet another embodiment, a token may be retrieved from the secure element (e.g., secure storage on the mobile device, such as an iPhone) and may be decrypted to determine the BIN or the IIN. In another embodiment, a token may be retrieved from local device memory of the mobile device (e.g., an Android device) and may be decrypted to determine the BIN or the IIN.

In one embodiment, instead of conducting a small transaction, the mobile application may retrieve the token from the secure element, device memory, etc. and determine if the BIN or IIN matches the financial institution/issuer.

In one embodiment, the mobile application may request that the operating system verify the BIN or IIN as the mobile application may not have permission to access the secure element.

In another embodiment, the mobile application may receive the token from the payment network and/or payment processor and may decrypt the token to determine if the BIN or IIN matches the financial institution/issuer.

Combinations of one or more of these methods for determining if the BIN or IIN matches the financial institution/issuer may be used as is necessary and/or desired.

In one embodiment, following validation, the transaction may be terminated and not conducted.

If the payment mechanism is associated with the financial institution/issuer, in step 265, the user may be presented with a redemption message instructing the user on how to redeem the incentive.

In one embodiment, the user may be automatically linked with an on-line application store to completed the redemption.

FIG. 3d depicts an example of a redemption message.

In one embodiment, a code may be transmitted to the on-line applications store when the redemption process is initiated. The code may be unique to the user, device, an account associated with the operating system (e.g., iTunes) ,etc. In one embodiment, the content associated with the redemption may be downloaded to a single device; in another embodiment, it may be associated with more than one device, such as devices that may use the mobile application. In another embodiment, the code may be shared with others.

In step 270, if the selected card is not associated with the financial institution/issuer, a check may be made to see if there are other payment mechanisms in the third party wallet application, or if any of the other cards are associated with the financial institution/issuer. If there are, in step 275, the user may be provided with a message instructing the user to select a card associated with the financial institution/issuer and try again. For example, the user may be presented with a message such as “Please select a card from the Financial Institution in order to redeem your free download.”

If there is only one payment mechanism (the one that was not associated with the financial institution/issuer, or there are no payment mechanisms in the third party wallet application that are associated with the financial institution/issuer, in step 280 the user may be instructed to add a payment mechanism manually, by imaging a payment card using the device's camera, through a tokenization process, etc.

Referring to FIG. 4, an exemplary tokenization process is illustrated. In step 405, the third party wallet application may request a token from a payment processor or a payment, such as Visa. In step 410, the request may be passed to the financial institution/issuer of the payment mechanism.

In step 415, the financial institution/issuer may perform any necessary fraud checks to verify the identity of the user that is requesting the token through the third party wallet application. In one embodiment, a check may be made to see if the user has accepted the terms and conditions associated with using the third party wallet application, and may be presented with such terms and conditions for acceptance.

In step 420, the financial institution/issuer may return the eligibility of the user for the token. In one embodiment, this may be provided on a scale (e.g., red, yellow, green, orange), with red indicating that the token is not authorized, green indicating that the token is authorized, and the others requiring additional user action or additional authentication.

In step 425, if a token is authorized, then in step 430 the payment processor or payment network may tokenize the account information, and may provide the tokenized account information and card art to the third party payment application. If the token was not authorized, or additional information or authentication is needed, in step 435, the user may be provided with a message indicating such.

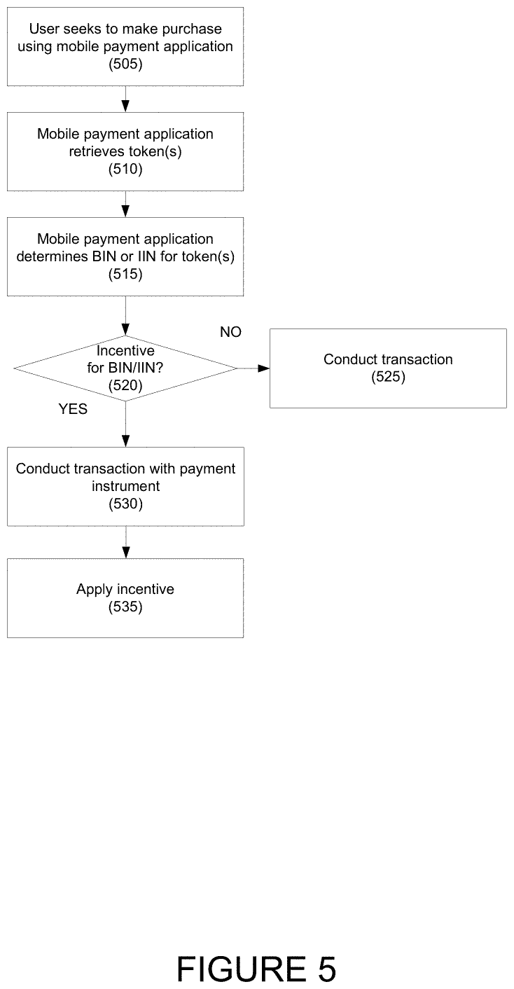

Referring to FIG. 5, a method for incentivizing the use of a payment mechanism is disclosed according to one embodiment. In step 505, a user may seek to make a purchase or conduct a transaction using, for example, a mobile payment application, such as Apple Pay, Samsung Pay, Google Pay, etc. In one embodiment, the mobile payment application may be conducting a transaction with a point of sale device, online, through a separate application (e.g., an in-app purchase), etc.

In step 510, the mobile payment app may retrieve a token, or part of a token, from the device's secure element (e.g., iPhone), local memory (e.g., Android device), etc., and may decrypt or otherwise process the token to determine the BIN or the IIN for a payment mechanism.

In one embodiment, only the token for the default payment mechanism may be retrieved. In another embodiment, tokens for other than the default payment mechanism may be retrieved in addition to the default payment mechanism. One or more of the non-default payment mechanism tokens may be decrypted to determine the BIN or IIN of the non-default payment mechanisms.

In step 515, the BIN or IIN for one or more token may be determine by decrypting one or more of the retrieved tokens.

In step 520, the mobile payment application may determine whether the BIN or IIN is associated with a financial institution, a merchant, etc. that offers an incentive for using their certain payment mechanism. In one embodiment, the payment mechanism may be associated with a particular issuer, with a merchant (e.g., co-branded, private label, stored value gift card, etc.), etc.

In one embodiment, only the BIN or IIN for the default payment mechanism may be checked for an incentive. In another embodiment, the BIN or IIN for non-default payment mechanisms may be checked for an incentive.

In one embodiment, if a non-default payment mechanism provides an incentive for using that payment mechanism, the mobile payment application may recommend a non-default payment mechanism for conducting the transaction.

In one embodiment, the user may select a non-default payment mechanism for the transaction.

In step 525, if the financial institution, a merchant, etc. for the BIN or IIN does not provide an incentive, the transaction may be conducted with the default payment mechanism.

In another embodiment, if tokens are retrieved for non-default payment mechanisms, and none of the financial institutions, merchants, etc. provide an incentive, the transaction may be conducted with the default payment mechanism.

If the financial institution, merchant, etc. associated with the BIN or IIN does provide an incentive, in step 530, the transaction may be completed, and, in step 535 the incentive may be applied. Any suitable incentive (e.g., discounts, coupons, rewards, goods/services, etc.) may be provided as is necessary and/or desired.

In one embodiment, if the incentive is associated with the current transaction (e.g., a discount), the incentive may be applied to the transaction when it is conducted, or it may be issued as a credit after the transaction is conducted. Any suitable way of applying the incentive may be used as is necessary and/or desired.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ 10 operating system, the Microsoft Windows™ 8 operating system, Microsoft Windows™ 7 operating system, the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1-8. (canceled)

9. A method for incentivizing the use of a payment instrument in a third party electronic payment service application, comprising:
a mobile computer application associated with a financial institution and executed by a mobile electronic device presenting, on a display of the mobile electronic device, a message comprising an incentive from an on-line applications store;
the mobile computer application receiving acceptance of the incentive;
the mobile computer application adding a payment instrument associated with the financial institution to an electronic wallet;
the mobile computer application providing the payment instrument to a third party electronic payment service application;
the mobile computer application generating an in-application purchase transaction;
the mobile computer application initializing and executing the third party electronic payment service application, during execution of the mobile computer application, wherein the third party electronic payment service application completes the in-application purchase transaction;
a financial institution computer system receiving the completed in-application purchase transaction with a payment instrument from the third party electronic payment service application;
the financial institution computer system verifying that the payment instrument is associated with the financial institution;
the mobile computer application presenting, on the display, a redemption message for the incentive; and
the mobile computer application transmitting a code to an on-line applications store to redeem the incentive.

10. The method of claim 9, wherein the transaction is a no-charge transaction.

11. The method of claim 9, wherein the financial institution computer system verifies that the payment instrument is associated with the financial institution by confirming that a Bank Identification Number (BIN) or an Issuer Identification Number (IIN) for the payment instrument is associated with the financial institution.

12. The method of claim 9, wherein the incentive comprises free or discounted music from the content provider.

13. The method of claim 9, wherein the incentive comprises a free or discounted application from the content provider.

14. The method of claim 9, wherein the mobile computer application is a mobile banking application.

15. The method of claim 9, further comprising:
the financial institution computer system receiving a request from the electronic payment service application for a token for the payment instrument; and
the financial institution computer system providing the electronic payment service application with the token for the payment instrument.

16. The method of claim 15, wherein the token is requested from a payment processing network.

17. The method of claim 15, wherein the token is requested from the financial institution.

18-21. (canceled)

22. The method of claim 9, wherein the incentive is redeemed with the on-line applications store by selecting a link provided by the mobile computer application.

23-24. (canceled)

25. The method of claim 9, wherein the in-application purchase transaction conducts the transaction with the financial institution.

26. (canceled)
